(19) United States
(12) Patent Application Publication
(10) Pub. No.: US 2013/0205108 A1
(43) Pub. Date: Aug. 8, 2013

(54) MANAGING RESERVATION-CONTROL IN A STORAGE SYSTEM

(71) Applicants: Itzhak PERELSTEIN, Hoshaya (IL); Eyal GORDON, Haifa (IL); Amir SASSON, Haifa (IL)

(72) Inventors: Itzhak PERELSTEIN, Hoshaya (IL); Eyal GORDON, Haifa (IL); Amir SASSON, Haifa (IL)

(73) Assignee: KAMINARIO TECHNOLOGIES LTD., Yokne'am ILIT (IL)

(21) Appl. No.: 13/366,525

(22) Filed: Feb. 6, 2012

(51) Int. Cl. G06F 12/16

(52) U.S. Cl. 711/162; 711/E12.103

(57) ABSTRACT

A method of managing reservation-control in a storage system that consists of a plurality of interfaces and a common storage resource, the method comprising responsive to receiving at an originator interface a reservation command related to the common storage resource, implementing a multi-phase reservation synchronization protocol including a lock phase consisting of locking the resource on a central controlling process, backing up respective lock phase data on a backup control process, and issuing a lock phase completion indication; an execution phase consisting of executing locally on each one of the plurality of interfaces a reservation operation, and issuing an execute phase completion indication; and an unlock phase consisting of unlocking the resource on the central controlling process; backing up respective unlock phase data on a backup control process, and issuing an unlock phase completion indication.

### FIELD OF THE INVENTION

The present invention is in the field of distributed storage systems management and control.

### SUMMARY OF THE INVENTION

Many of the functional components of the presently disclosed subject matter can be implemented in various forms, for example, as hardware circuits comprising custom VLSI circuits or gate arrays, or the like, as programmable hardware devices such as FPGAs or the like, or as a software program code stored on an intangible computer readable medium and executable by various processors, and any combination thereof. A specific component of the presently disclosed subject matter can be formed by one particular segment of software code, or by a plurality of segments, which can be joined together and collectively act or behave according to the presently disclosed limitations attributed to the respective component. For example, the component can be distributed over several code segments such as objects, procedures, and functions, and can originate from several programs or program files which operate in conjunction to provide the presently disclosed component.

In a similar manner, the presently disclosed component(s) can be embodied in operational data or operation data can be used by the presently disclosed component(s). By way of example, such operational data can be stored on a tangible computer readable medium. The operational data can be a single data set, or can be an aggregation of data stored at different locations, on different network nodes, or on different storage devices.

The method or apparatus according to the subject matter of the present application can have features of different aspects described above or below, or their equivalents, in any combination thereof, which can also be combined with any feature or features of the method or apparatus described in the Detailed Description presented below, or their equivalents.

Examples of the presently disclosed subject matter relate to a method and a device for managing reservation-control in a storage system that consists of a plurality of interfaces and a common storage resource. According to examples of the presently disclosed subject matter, a method of managing reservation-control in a storage system that consists of a plurality of interfaces and a common storage resource includes implementing a multi-phase reservation synchronization protocol in response to receiving at an originator interface service a reservation command related to the common storage resource. The multi-phase reservation synchronization protocol includes: a lock phase, and execute phase and an unlock phase. The lock phase can consist of locking the resource on a central controlling process, backing up respective lock phase data on a backup control process, and issuing a lock phase completion indication. The execution phase can consist of executing locally on each one of the plurality of interfaces a reservation operation, and issuing an execute phase completion indication. The unlock phase can consist of: unlocking the resource on the central controlling process; backing up respective unlock phase data on a backup control process, and issuing an unlock phase completion indication.

According to examples of the presently disclosed subject matter, upon receiving the unlock phase completion indication, the originator interface is adapted to issue a completion indication to an initiator of the reservation command.

According to examples of the presently disclosed subject matter, the lock phase can be initiated by the originator interface in response to receiving the reservation command, and the execution and unlock phases can be initiated by the originator in response to receiving the lock phase completion and the execute phase completion indications, respectively.

According to examples of the presently disclosed subject matter, the method can further include: receiving at the originator interface the reservation command; forwarding the reservation command to the central controlling process, and wherein the multi-phase reservation synchronization protocol is initiated for the reservation command by the central controlling process, including initiating the lock phase, the execution phase and the unlock phase.

According to examples of the presently disclosed subject matter, the execution phase can include receiving at the central controlling process an acknowledgment of the execution of the reservation operation on each one of the plurality of interfaces, and wherein issuing an execute phase completion indication is responsive to receiving at the central controlling process an acknowledgment of the execution of the reservation operation on each one of the plurality of interfaces.

According to examples of the presently disclosed subject matter, the method can further include: in case the central controlling process failed configuring the backup control process as a replacement controlling process, implementing a takeover process including requesting each one of the plurality of interfaces to provide the replacement controlling process with any reservation phase command that was issued by the interface and for which no response was received from the central controlling process, and processing responses from the plurality of interfaces using the back up phase data to determine a current phase of a reservation command.

According to a further aspect of the presently disclosed subject matter, there is provided a storage system. In accordance with examples of the presently disclosed subject matter, the storage system includes: a plurality of interfaces, a common storage resource, a central controlling process and a backup controlling process. An originator interface from amongst the plurality of interfaces can receive a reservation command related to the common storage resource, and in response to receiving the reservation command, a multi-phase reservation synchronization protocol can be implemented in the storage system. The multi-phase reservation synchronization protocol can include: a lock, an execution phase and an unlock phase. The lock phase can consist of: locking the common storage resource on the central controlling process, backing up lock phase data related to the lock on a backup control process, and issuing a lock phase completion indication to the originator interface. The execution phase can consist of: executing locally on each one of the plurality of interfaces a reservation operation, and issuing an execute phase completion indication to the originator interface. The unlock phase can consist of: unlocking the resource on the central controlling process, backing up respective unlock phase data on a backup control process, and issuing an unlock phase completion indication to the originator.

According to a further aspect of the presently disclosed subject matter, there is provided a program storage device readable by machine, tangibly embodying a program of instructions executable by the machine to perform a method of managing reservation-control in a storage system that consists of a plurality of interfaces and a common storage resource.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic block diagram showing a plurality of network nodes interconnected by a multi-path channel and implementing a software module, a computer service or a device for managing a multi-path channel, as part of examples of the presently disclosed subject matter;

FIG. 2 is a flowchart illustration of a method of managing reservation-control in a storage system that consists of a plurality of interfaces and a common storage resource, according to examples of the presently disclosed subject matter;

FIG. 3 is a flowchart illustration of one possible implementation of the multiphase reservation synchronization protocol according to examples of the presently disclosed subject matter;

FIG. 4 is a flowchart illustration of one possible implementation of the multiphase reservation synchronization protocol according to examples of the presently disclosed subject matter;

FIG. 5 is a flowchart illustration of one possible implementation of the multiphase reservation synchronization protocol according to examples of the presently disclosed subject matter;

FIG. 6 is a block diagram illustration of a CCP according to examples of the presently disclosed subject matter;

FIG. 7 is a block diagram illustration of one of the multiple interfaces of the storage system, according to examples of the presently disclosed subject matter; and

FIG. 8 is a block diagram illustration of a BCP according to examples of the presently disclosed subject matter.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures and components have not been described in detail so as not to obscure the presently disclosed subject matter.

Unless specifically stated otherwise, as apparent from the following discussions, it is appreciated that throughout the specification discussions various functional terms refer to the action and/or processes of a computer or computing device, or similar electronic computing device, that manipulate and/or transform data represented as physical, such as electronic, quantities within the computing device's registers and/or memories into other data similarly represented as physical quantities within the computing device's memories, registers or other such tangible information storage, transmission or display devices.

Examples of the presently disclosed subject matter relate to a method of managing reservation-control in a storage system that consists of a plurality of interfaces and a common storage resource, and to a storage system that consists of a plurality of interfaces and a common storage resource and which is configured for implementing the method of managing reservation-control. According to examples of the presently disclosed subject matter the method of managing reservation-control in a storage system that consists of a plurality of interfaces and a common storage resource can include a lock phase, an execution phase and an unlock phase. The lock phase can consist of: locking the resource on a central controlling process, backing up respective lock phase data on a backup control process, and issuing a lock phase completion indication. The execution phase can consist of: executing locally on each one of the plurality of interfaces a reservation operation, and issuing an execute phase completion indication. The unlock phase can consist of: unlocking the resource on the central controlling process, backing up respective unlock phase data on a backup control process, and issuing an unlock phase completion indication. For convenience, and by way of non-limiting example, the above combination of the lock phase, execution phase and unlock phase is sometimes referred to herein as the “multiphase reservation synchronization protocol”.

Throughout the description and in the claims, reference is made to the term “persistent reservation” (“PR”), “persistent reservation command” and the like. The meaning of the term persistent reservation command is well-known in the pertinent art. The following definition is provided by way of non-limiting example. A persistent reservation command is a command which enables an initiator of the command to reserve a logical unit for various purposes, until the logical unit is realized, for example by the same initiator. By way of example, a SCSI persistent reservation command (PR), which is part of the SCSI protocol definition, enables SCSI to establish, preempt, query, or reset a reservation policy for a specified target SCSI Logical Unit (LU). It would be appreciated that some examples of the presently disclosed subject matter can be used for managing a storage system process which is implemented in response to and in association with other commands that require utilization of a central control process for synchronizing a state across a plurality of interfaces. In further examples of the presently disclosed subject matter, such other commands may also relate to a common storage resource. Further by way of example, some examples of the presently disclosed subject matter can be used for managing a storage system process which is implemented in response to and in association with an LU reset command.

According to examples of the presently disclosed subject matter, the multiphase reservation synchronization protocol is initiated by an originator interface of the storage system which received a respective reservation command, e.g., from an external host. As used herein the term “originator interface”, relates to the interface (of a storage system) which received the reservation command in respect of which the multi-phase reservation synchronization protocol is implemented. It would be appreciated that in a storage system, and in particular in mass storage systems, a plurality of interfaces can be used for interfacing with hosts (and possibly with other external entities). Accordingly, when a reservation command, e.g., from a host, is received at a storage system that includes multiple interfaces, the interface through which the reservation command is originally received is the original interface for this reservation command. According to examples of the presently disclosed subject matter, the lock phase is initiated by the originator interface in response to receiving a reservation command, and said execution and unlock phases are initiated by the originator interface in response to receiving the lock phase completion and the execute phase completion indications, respectively.

It would be appreciated that the reservation operation on the originator interface can be implemented independently of the execution phase, and in such a case, the execution phase is implemented with respect to the other interfaces in the storage system. In other words, in some examples of the presently disclosed subject matter, the originator interface is excluded from the plurality of interfaces that are involved in the execution phase. In accordance with examples of the presently disclosed subject matter, the originator is configured to perform the persistent reservation command locally, prior to sending the execution phase command to the central controlling process.

According to examples of the presently disclosed subject matter, in response to the unlock phase completion indication, e.g. issued by the central controlling process, an indication can be issued, e.g., by the originator interface process, that the persistent reservation operation has been completed.

In further examples of the presently disclosed subject matter, upon receiving at OIS the reservation command, forwarding the reservation command to the central controlling process, and the multi-phase reservation synchronization protocol is initiated in respect of the reservation command by the central controlling process. The term “central controlling process” or in abbreviation “CCP” relates to the process which is configured to manage the storage system. By way of example, the CCP can be responsible for the following: initiation of the system (“turning it on”); shutting down the system; implementing system configurations; monitoring the system's processes; monitoring the system resources; handle failures, and error conditions in the system, including restoring components and/or data, recovering data, etc. It would be appreciated that the CCP can perform various other management tasks, as is well known in the art. It would be further appreciated that the CCP can be implemented as a dedicated (including distributed) hardware component, a firmware program and/or as software.

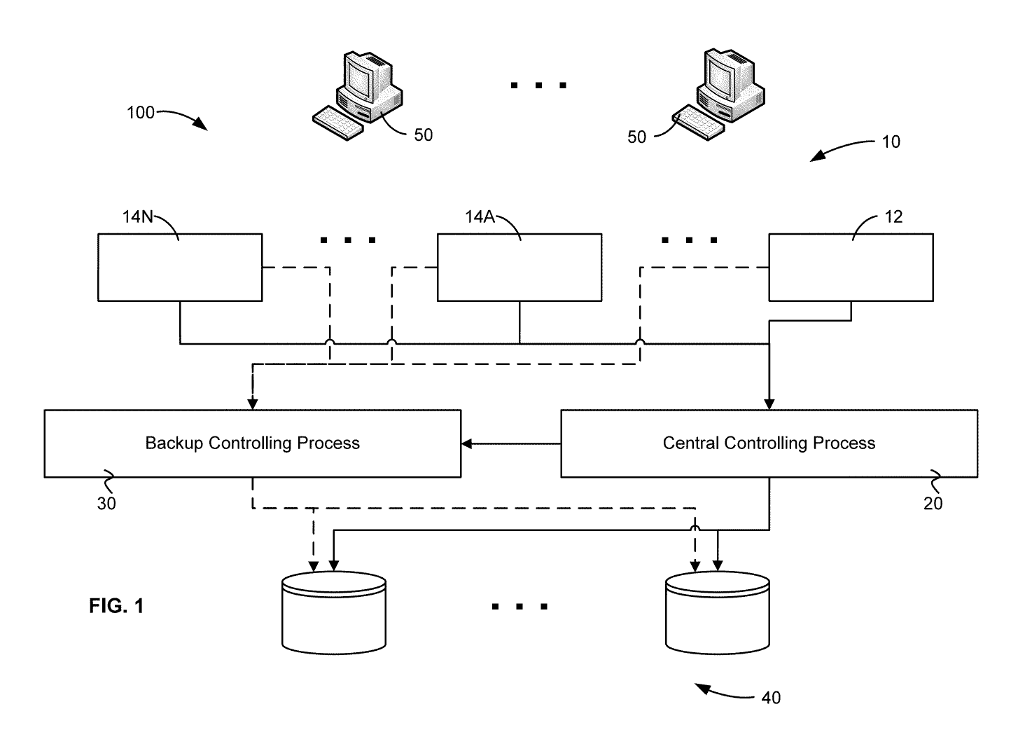

Reference is now made to FIG. 1, which is a block diagram illustration of a storage system that is configured for managing reservation control related to a plurality of interfaces and a common storage resource, according to examples of the presently disclosed subject matter. A storage system 100 according to examples of the presently disclosed subject matter can include multiple interfaces 10, a central controlling process 20, a backup controlling process 30, and a common storage resource 40. The storage system 100 can be operatively connected to external entities, such as hosts 50.

According to examples of the presently disclosed subject matter, the hosts 50 (or any other external entity operating in a similar manner) can issue commands to the storage system, including persistent reservation commands. The multiple interfaces 10 are utilized by the storage system 100 for receiving incoming communications, including incoming reservation commands. Thus, when a host 50 issues a reservation command it is received in the storage system 100 by one of the multiple interfaces 10. The interface which received the incoming reservation command is referred to as the originator interface 12. The other interfaces 14A-14N include the remaining interfaces (the ones that did not receive the reservation command). According to examples of the presently disclosed subject matter, interfaces 14A-14N can include any number of interfaces from one and above (e.g., one, two, three, etc.)

According to examples of the presently disclosed subject matter, the interfaces 10 are associated with a common storage resource 40 of the storage system 100. For example, the storage system 100 can include one or more physical storage media where data can be stored and from which the data stored in the storage system can be retrieved. Further by way of example, the common storage resource 40 can include a plurality of storage units. Each one of the plurality of storage units can provision multiple physical storage addresses. A logical layer can be implemented over the plurality of storage units, and logical storage addresses can be mapped to the physical storage locations provisioned by the plurality of storage units. This configuration is commonly known in the field of storage systems as “virtualization”.

The interfaces 10 receive incoming commands, such as I/O command and reservation commands, for example, from hosts 50. The commands from the hosts can be addressed to virtual resources and can reference the logical storage addresses (such as LUNs) of the virtual resources to which the commands relate. The logical addresses are translated to physical storage addresses. For example at least some of the logical address can be associated with physical storage locations on the common storage resource 40. When a command is determined to be associated with physical storage locations on the common storage resource 40, the command can be directed to the common storage resource 40 as part of the servicing of the command.

According to examples of the presently disclosed subject matter, each one of the interfaces 10 is operatively connected to the central controlling process 20. The CCP 20 can be configured to control and synchronize the servicing of reservation commands which are received at the storage system 100 through the interfaces 10. It would be appreciated that the CCP 20 can be adapted to control other operations within the storage system which involve the common storage resource 40 and synchronization among the interface 10. For example, the CCP can be adapted to perform or manage the following operations: mapping between logical storage addresses and corresponding physical storage locations, initiating and controlling operations on the logical storage layer (with respect to logical storage addresses), implementing and controlling host configurations, mapping between hosts and logical storage resources, etc. According to still further examples of the presently disclosed subject matter, the central controlling process 20 can be configured to control the interaction between the interfaces 10 and the common storage resource.

According to examples of the presently disclosed subject matter, the backup controlling process 30 can provide a backup for the CCP 20, and in case the CCP 20 fails, the BCP 30 can replace it as the central controlling process. The interaction between the CCP 20 and BCP 30 during normal operation and following a failure of the central controlling process are described below.

In some examples of the presently disclosed subject matter, the common shared storage resource 40 is a single storage unit. In other examples, a plurality of storage units, possibly with some level of logical abstraction (virtualization) constitute the common storage resource 40. In any case, the interfaces 10 can expose to the external hosts 50 logical storage addresses which are defined over the physical storage locations provisioned by the physical storage unit(s), and mapping tables can be used to translate the logical storage addresses to the corresponding physical storage locations and vice-versa.

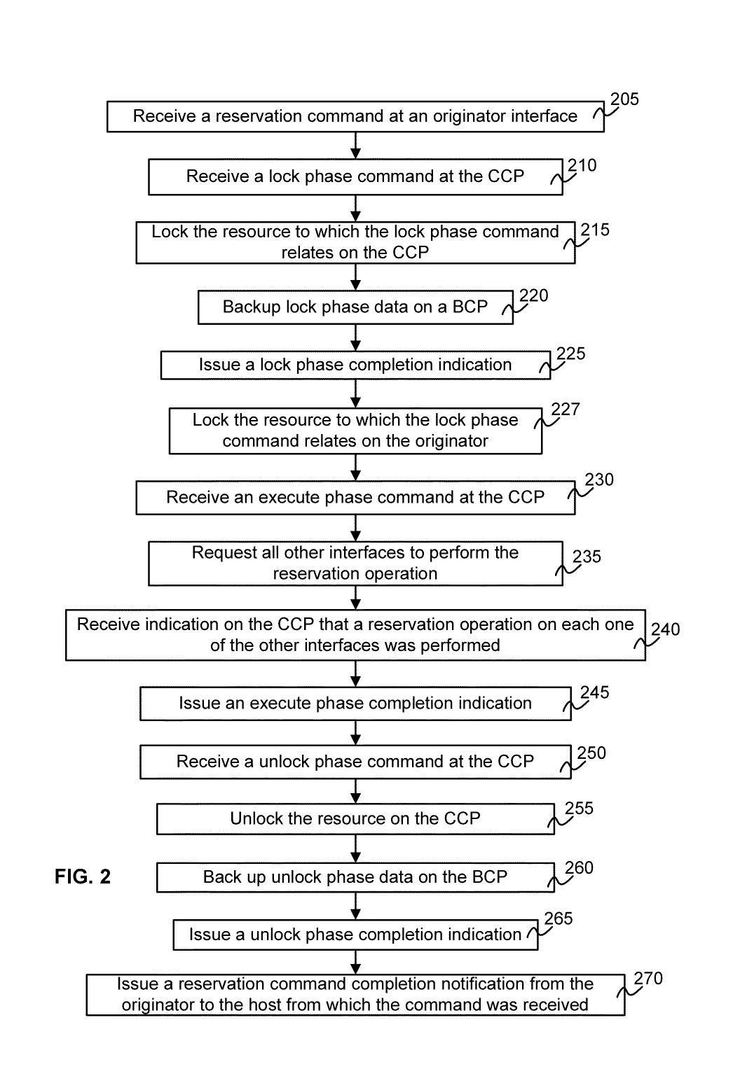

Reference is now additionally made to FIG. 2, which is a flowchart illustration of a method of managing reservation-control in a storage system that consists of a plurality of interfaces and a common storage resource, according to examples of the presently disclosed subject matter. According to non-limiting examples of the presently disclosed subject matter, the method of managing reservation-control in a storage system that consists of a plurality of interfaces and a common storage resource can be implemented by the storage system 100 shown in FIG. 1 and described above. However, the methods described herein are not necessarily limited to being implemented by this system and can be implemented by other suitable systems.

According to examples of the presently disclosed subject matter, at some point, a host 50 may issue a reservation command and communicate the reservation command to the storage system 100. In the storage system 100, the reservation command from the host 50 is received by an interface 12 from amongst the multiple interfaces 10. The details concerning the process that is used to determine which interface from amongst the multiple interfaces 10 is to receive a particular communication from a host 50 are known to those versed in the art and are beyond the scope of the present invention. For convenience it is assumed that the interface process through which a reservation command is received in the storage system 100 is also the originator of the reservation command within the storage system. For convenience, the originator interface is marked in FIG. 1 with the numeral 12, while the other interfaces (there could be one or more of those) are marked in FIG. 1 as elements 14A-14N.

The process illustrated in FIG. 2 begins when a reservation command (e.g., from a host 50) is received at interface (block 205). The interface which received the reservation command is referred to herein as an originator interface 12.

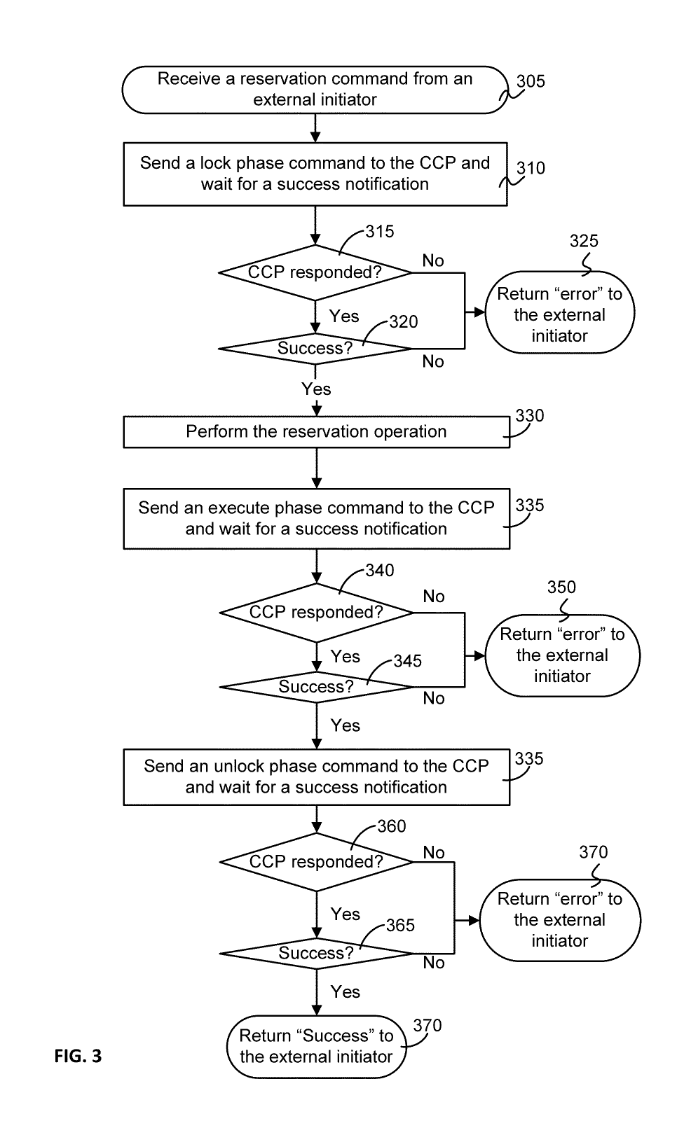

According to examples of the presently disclosed subject matter, upon receiving a reservation command, the originator service can issue a lock phase command to the CCP 20, and the CCP 20 may receive the lock phase command (block 210). According to examples of the presently disclosed subject matter, each phase command (lock phase command, execute phase command, unlock phase command) can have the following data fields: command buffer (contains the command sent from the host to the originator), an originator where the originator interface is specified, common resource descriptor (e.g. LU, LBA range, physical location locations etc.), and a command ID which is substantially uniquely associated with the respective reserve command. It would be appreciated that while in FIG. 3 and elsewhere in the present disclosure the lock phase command, as well as the other phase commands, are sometimes described as relating to an LU, this is only a non-limiting example, and that the phase commands, which are implemented as part of the multiphase reservation synchronization protocol, can relate to any storage resource unit that is defined and recognized by the components of the storage system that are involved in the exchange or processing of the phase commands. In this regard, it would be appreciated that in some examples of the presently disclosed subject matter, the phase commands can relate to a physical storage segment(s) or to a logical storage segment(s). Also, as mentioned above, in examples of the presently disclosed subject matter, the multiphase reservation synchronization protocol can be used for enabling multiple interfaces which operate with respect to a common storage resource to synchronize (or to be synchronized) a reservation of the common storage resource or some part thereof. Accordingly, in some examples of the presently disclosed subject matter, the term LU is sometimes replaced with the term “common storage resource”.

Furthermore, in this example, the initiation of the lock phase command and of the multiphase reservation synchronization protocol is carried out by the originator interface. However, in accordance with further examples of the presently disclosed subject matter, the multiphase reservation synchronization protocol can also be managed by the CCP 20. That is, according to examples of the presently disclosed subject matter, upon receiving a reservation command the originator can be configured to transfer the command to the CCP 20, and the CCP can be configured to initiate the multiphase protocol.

According to examples of the presently disclosed subject matter, upon receiving the lock phase command at the CCP 20, the CCP 20 can be adapted to lock the resource to which the phase command relates on the CCP 20 (block 215). According to examples of the presently disclosed subject matter, in case the resource is already reserved by a previous reservation command the CCP 20 can deny or simply ignore the lock phase command, and the originator interface 12 can be configured to send back to the initiator a failure notification when the reservation command is denied by the CCP 20 or a timeout occurs. In other examples of the presently disclosed subject matter, multiple concurrent reservation commands which relate to the same resource can be executed serially.

According to examples of the presently disclosed subject matter, following or substantially concurrently with the locking of the resource to which the lock LU phase command relates (block 215), the lock phase data can be backed up on the BCP 30 (block 220). For example, according to examples of the presently disclosed subject matter, the CCP 20 can be configured to issue a backup message with the lock phase data upon locking locally the resource to which the lock LU phase command relates. The BCP 30 can be configured to store lock phase data upon receiving the backup message from the CCP 20. The BCP 30 can be configured to hold an internal data structure where the lock phase data is backed up, and can be responsive to a new backup message for adding/overriding appropriate records in the internal data structure.

According to examples of the presently disclosed subject matter, once the lock phase data is backed up on the BCP 30, a lock phase completion indication can be issued (block 225). Further by way of example, following the backing up of the lock phase data on the BCP 30, the BCP 30 can indicate to the CCP 20 that the lock phase data is backed up. In response to the indication from the BCP 30, the CCP 20 can communicate to the originator interface 12 the lock phase completion indication.

According to examples of the presently disclosed subject matter, following the lock phase completion, the originator interface 12 can be configured to lock the resource to which the reservation command relates (block 227), and issue an “execute phase” command to the CCP 20. According to examples of the presently disclosed subject matter the execute phase command can be received at the CCP 20 (block 230). According to examples of the presently disclosed subject matter, the originator interface 12 can be responsive to receiving the lock phase completion indication for issuing the execute phase command.

According to examples of the presently disclosed subject matter, the CCP 20 can be responsive to receiving the execute phase command for issuing a reservation command related to the common resource to each one of the plurality of interface 14A-14N (block 235). According to examples of the presently disclosed subject matter, the CCP 20 can maintain and manage a list of all active interfaces 10. When an execute phase command is received, the CCP 20 can look up the interfaces 14A-14N other than the originator interface and can issue a reservation command to these interfaces 14A-14N with respect to the common storage resource for which the original reservation command (e.g., from the host 50) was intended.

According to examples of the presently disclosed subject matter, the CCP 20 then listens for success notifications from each one of the plurality of the interfaces 14A-14N which indicate that the respective interface performed the reservation operation locally (with respect to the resource designated in the command). The CCP 20 can be configured to handle cases where one or more of the plurality of interfaces 14A-14N did not respond to the reservation command (a success notification was not received), as will be discussed below. According to examples of the presently disclosed subject matter, at some point, the CCP 20 can receive success notifications from all the interfaces 14A-14N which indicate that the interfaces all (except those that failed, if any) performed the reservation operation locally (block 240). Further according to examples of the presently disclosed subject matter, the CCP 20 can be responsive to receiving success notifications from all the interfaces 14A-14N which indicate that the interfaces performed the reservation operation locally, for issuing an “execute phase complete” indication (block 245). According to examples of the presently disclosed subject matter, the execute phase completion indication can be received at the originator interface 12.

According to examples of the presently disclosed subject matter, the originator interface 12 can be responsive to receiving the execute phase completion indication for issuing an “unlock phase” command. According to examples of the presently disclosed subject matter, the CCP 20 is configured to received the unlock phase command (block 250), and the CCP 20 can be responsive to receiving the unlock phase command for locally unlocking the resource to which the unlock phase command relates (block 255).

According to examples of the presently disclosed subject matter, following or substantially concurrently with the unlocking of the resource to which the unlock phase command relates (block 255), the unlock phase data can be backed up on the BCP 30 (block 260). For example, according to examples of the presently disclosed subject matter, the CCP 20 can be configured to issue a backup message with the unlock phase data upon unlocking locally the resource to which the unlock LU phase command relates. The BCP 30 can be configured to store unlock phase data upon receiving the backup message from the CCP 20. The storing of the backup unlock phase data on the BCP can be carried out in a similar manner to the storage of the lock phase data which was described above.

It would be appreciated that some examples of the presently disclosed subject matter provide a reservation synchronization protocol that can be used in a storage system that consists of a plurality of interfaces and a common storage resource to enable support for reservation commands (e.g., from hosts) which relate to the common storage resource. Furthermore, it would be appreciated that examples of the presently disclosed subject matter, provide a fault tolerant implementation supporting the reservation synchronization protocol, and that in accordance with examples of the presently disclosed subject matter the reservation synchronization protocol supports recovery from failure of the CCP, at various stages of the protocol, as will be further discussed below.

Reference is now made to FIG. 3, which is a flowchart illustration of one possible implementation of the multiphase reservation synchronization protocol according to examples of the presently disclosed subject matter. In FIG. 3, according to examples of the presently disclosed subject matter, the focus is on the originator interface 12, and more particularly on the involvement of the originator interface 12 in the multiphase reservation synchronization protocol. It would be appreciated that the process shown in FIG. 3 and described herein or at least some of the blocks of the process, provide a non-limiting example of a possible implementation of the managing reservation-control in a storage system that consists of a plurality of interfaces and a common storage resource.

At some point, a reservation command can be received at the storage system 100 from an external initiator (block 305). For example, the reservation command is a persistent reservation command which relates to a resource 40 of the storage system with which at least one more interface (e.g., interfaces 14A-14N) of the storage system 100 is associated.

Since there are multiple interfaces 10 in the storage system, and incoming commands are distributed among the interfaces 10, the reservation command is received by one of the interfaces, for example, the one denoted by the numeral 12. According to examples of the presently disclosed subject matter, upon receiving the reservation command, the originator interface 12 is configured to send a lock phase command to the PCP 20 reference the resource to which the lock phase command relates. According to examples of the presently disclosed subject matter, and as is shown in FIG. 3, the phase command can be a lock LU phase command, and the resource to which the lock phase command relates can be an LU defined in the storage system 100 (block 310).

Next, the originator interface 12 can wait for a success notification from the CCP 20 (block 315). In case the originator interface 12 did not receive a success notification for the lock phase command from the CCP 20, the originator interface 12 can be configured to issue an error notification to the external initiator (block 325).

According to examples of the presently disclosed subject matter, various conditions can lead to failure to receive a success notification from the CCP 20 for the lock phase command. The originator interface, the CCP 20 and/or both can have certain provisions for detecting such failure situations and for resolving them. As will be further described below, according to examples of the presently disclosed subject matter, in case the CCP 20 fails, a takeover process can be initiated, whereby the BCP 30 takeover the role of the central controlling process.

For example, as part of the takeover process, the BCP 30 can be configured to send queries to the interfaces 10, requesting them to notify it of any pending reservation phase commands for which the interface issued a reservation phase command (lock phase command, execute phase command or unlock phase command) but for which no success or completion notification was received. When the BCP 30 detects that a phase command was issued by an interface of which it is not aware, the BCP 30 can either request the relevant interface to resend the phase command, or the BCP 30 can extract the necessary phase command data from the interface's response to the query, and the BCP 30 can resume servicing the command according to the interface's response.

Further by way of example, the originator interface 12 can implement a timeout clock. Following communication of a phase command to the CCP 20, the originator interface 12 can activate the timeout timer, and when the timeout timer expires, the originator interface 12 can automatically resend the phase command to the CCP 20. Still further by way of example, following the timeout expiring one or more times (e.g., after one timeout, two timeouts, three timeouts, etc.) the originator interface 12 can determine that the CCP 20 has failed, and can instruct the BCP 30 to take over the role of the CCP 20. As will be explained below, in some examples of the presently disclosed subject matter, the BCP 30 is configured, under certain circumstances, such as when the CCP 20 fails to take on the role of the CCP in the storage system 100. The BCP thus becomes the CCP 20 and starts to operate as a CCP 20 according to the data stored thereon. Since, in accordance with examples of the presently disclosed subject matter, the data from the CCP 20 is routinely backed up on the BCP 30, the BCP 30 can take over the role of the CCP 20, as will be further explained below.

Resuming now the description of FIG. 3, blocks 320 and 325 relate to another condition where the reservation command cannot be serviced, that is when an indication is received from the CCP 20 that it (the CCP 20) cannot perform the local lock with respect to the common storage resource referenced in the lock phase command. According to examples of the presently disclosed subject matter, the CCP 20 can be configured to indicate that it cannot perform the local lock with respect to the common storage resource referenced in the lock phase command in case of a timeout, or when the command parameters given by the initiator are invalid (e.g., LUN that does not exist).

According to examples of the presently disclosed subject matter, when an indication is received from the CCP 20 that it (the CCP 20) cannot perform the local lock with respect to the common storage resource referenced in the lock phase command, the originator interface 12 can be configured to communicate an “error” response to the initiator of the reservation command (e.g., a host 50) (block 325).

In case the CCP 20 reported success in response to the lock phase command, the originator interface 12 can be configured to perform locally the reservation operation (block 330). As mentioned above, according to examples of the presently disclosed subject matter, the CCP 20 is configured to issue a success notification in response to the lock phase command after the respective lock phase data from the CCP 20 was successfully backed up on the BCP 30.

According to examples of the presently disclosed subject matter, further in response to receiving the success notification related to the lock phase command from the CCP 20, and concurrently or in succession with performing the local reservation operation, the originator interface 12 can be configured to issue an execute phase command, send it to the CCP 20 and wait for a response from the CCP (block 335). In this phase, similar failure detection and control measures can be implemented as were described above in connection with the lock phase. Blocks 340-350 relate to a measure (or measures) which can be used to allow the originator interface 12 to issue an error notification to the initiator in case no response is received from the CCP 20 or in case the CCP 20 reported a failure back to the originator interface 12, and move to the unlock phase in case the CCP 20 reports success for the execute phase command. According to examples of the presently disclosed subject matter, the CCP 20 can be configured to report a failure in response to the execution phase command, in case an execution phase command is received, without first implementing the lock phase, etc.

As was mentioned above, according to examples of the presently disclosed subject matter, in response to receiving the execute phase command at the CCP 20, the CCP 20 is configured to issuing a respective reservation command to each one of the plurality of interfaces 14A-14N. Further by way of example, following to the issuing of the reservation commands to each one of the plurality of interfaces 14A-14N, the CCP 20 can be configured to listen for success notifications from each one of the plurality the interfaces 14A-14N indicating that the respective interface performed the reservation operation locally (with respect to the resource designated in the command), and upon receiving success notifications from all the interfaces 14A-14N, the CCP 20 is configured to issue the success response notification to the originator interface 12.

According to examples of the presently disclosed subject matter, the originator interface 12 is responsive to receiving a success notification from the CCP 20 for issuing an unlock phase command to the CCP 20 (block 355).

Blocks 360-365 relate to a measure (or measures) which can be used to allow the originator interface 12 to issue an error notification to the initiator in case no response is received from the CCP 20 or in case the CCP 20 reported a failure back to the originator interface 12. In case the originator interface 12 received a success notification from the CCP 20 in response to the unlock command, originator interface 12 can be configured to issue a success notification to the initiator of the reservation command (block 370). According to examples of the presently disclosed subject matter, in response to the success notification, the initiator can be configured to perform various operations, including for example: following a persistent reservation register command, the initiator can be configured to issue a persistent reservation command, following a persistent reservation command the initiator can be configured to initiate I/O(s) towards the reserved resource.

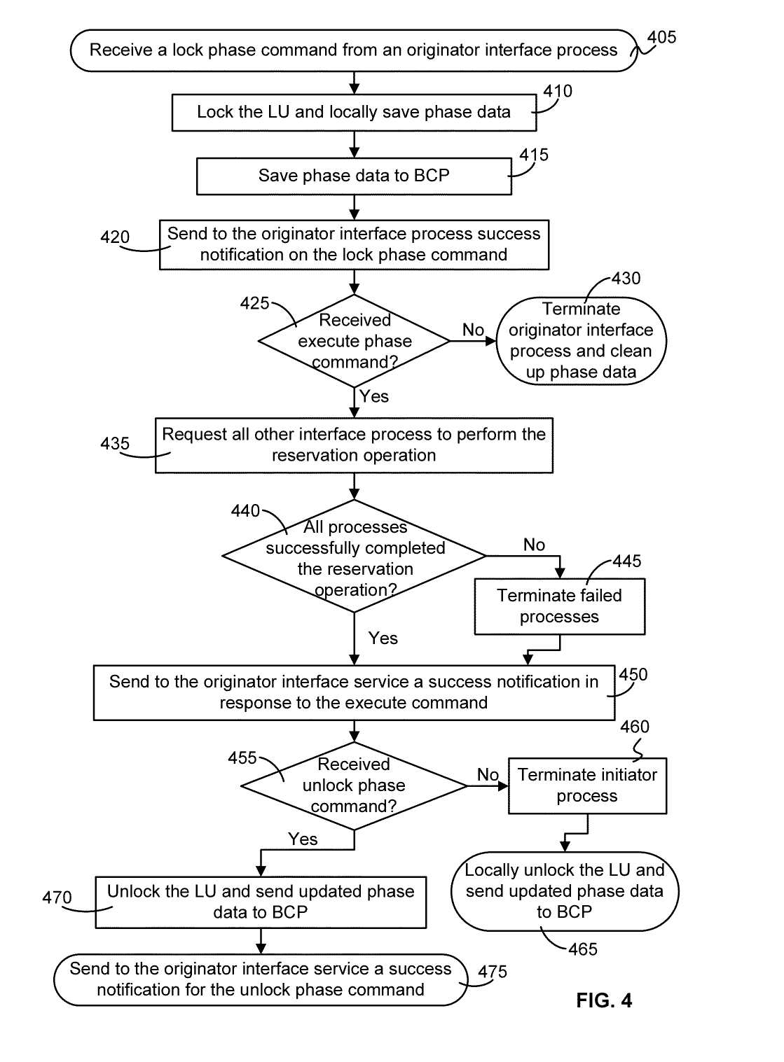

Turning now to FIG. 4, there is shown a flowchart illustration of one possible implementation of the multiphase reservation synchronization protocol according to examples of the presently disclosed subject matter. In FIG. 4, in accordance with examples of the presently disclosed subject matter, the focus is on the CCP 20, and more particularly on the involvement of the CCP 20 in the multiphase reservation synchronization protocol.

According to examples of the presently disclosed subject matter, at some point, a “Lock LU” phase command can be received at the CCP 20 (block 405), for example, from an originator interface 12 which received a reservation command from a host 50. As mentioned above, the multiphase reservation synchronization protocol and the phase commands are not limited to LUs and can relate to any common storage resource unit that is defined and recognized by the components of the storage system that are involved in the exchange or processing of the phase commands. Here too, the term LU is sometimes replaced with the term “common storage resource”.

According to examples of the presently disclosed subject matter, the CCP 20 can be configured to locally lock the storage resource (e.g., LU) referenced by the lock phase command in response to receiving the lock phase command from the originator interface, and the CCP 20 can save the phase data, for example, in a phase registry of the CCP 20 (block 410).

Next, according to examples of the presently disclosed subject matter, the CCP 20 can be configured to backup the phase data on a BCP 30 (block 415). By way of example, the CCP 20 can provide as input to the BCP the phase data which the CCP 20 stored locally in connection with the local lock on the CCP 20 (both in response to the phase command received from the originator interface 12). The BCP 30 can be configured to record the phase data, for example in a backup database, table, list or in any other appropriate data structure of the BCP 30, and in any suitable format.

According to examples of the presently disclosed subject matter, once the CCP 20 receives an acknowledgement or a success notification from the BCP 30 indicating that the lock phase data was successfully backed up on the BCP 30, the CCP 20 can be configured to send a success notification to the originator interface 12 (block 420) indicating that the CCP 20 successfully performed the lock phase operations, or in this case that blocks 405-415 completed successfully.

Following communication of the success notification related to the lock phase command, the CCP 20 can be configured to wait for an execute phase command (block 425), for example from the originator interface 12. According to examples of the presently disclosed subject matter, the CCP 20 can be configured to wait for the execute phase command, and in case the execute phase command is not received within a certain time period, the CCP 20 can be configured to terminate the originator interface process 12 and to remove the lock phase data record associated with the failed execute phase command (the data that was recorded in block 410) (block 430).

According to examples of the presently disclosed subject matter, further in response to a failed execute phase command (e.g., the execute phase command is not received at the CCP 20 within a certain period of time following the communication of the success notification), the CCP 20 can instruct the BCP 30 to remove or otherwise invalidate the backup data stored thereon which corresponds to the lock phase data related to the failed execute phase command.

According to examples of the presently disclosed subject matter, in case an execute phase command is received at the CCP 20, e.g., from the originator interface 12, the CCP 20 is configured to request all the other interface processes 14A-14N to reserve locally the storage resource (e.g., LU) to which the original reservation command (from the host 50) relates (block 435). According to examples of the presently disclosed subject matter, the CCP 20 can be configured to wait for a success notification from each one of the other interface processes 14A-14N, which indicates that the respective interface successfully reserved (locally) the storage resource reference in the reservation command from the CCP 20 (e.g., LU). According to examples of the presently disclosed subject matter, the CCP 20 can implement a timeout period (e.g., starting from the transmission of the reservation command to the other interfaces 14A-14N), and the CCP 20 can determine which, if any, interfaces did not respond with success to the reservation command (block 440).

According to examples of the presently disclosed subject matter, the CCP 20 can be configured to terminate any interface from which a success notification was not received (block 445). Further by way of example, in case a certain interface process does not respond to the reservation command from the CCP 20 within a certain period of time, the CCP 20 can be configured to regard this interface as failed and can terminate it. It would be appreciated that any failure detection measure that is implemented as part of the multiphase reservation synchronization protocol according to examples of the presently disclosed subject matter can include a reattempt operation that can be used to give a second (or third, etc.) chance for the necessary operation to complete in case of some momentary delay or malfunction that is resolved in some way before or during the reattempt.

According to examples of the presently disclosed subject matter, following block 440, in case all of the other interfaces 14A-14N reported success back to the CCP 20 in response to the reservation command from the CCP 20, or following block 445 in case one or more of the interfaces failed to respond with success (or did not respond at all) and were terminated, the CCP 20 can be configured to send a success notification to the originator interface 12 in response to the execute phase command (block 450).

According to examples of the presently disclosed subject matter, following communication of the success notification related to the execute phase command, the CCP 20 can be configured to wait for an unlock phase command (block 455), for example from the originator interface 12.

According to examples of the presently disclosed subject matter, the CCP 20 can be configured to terminate the originator interface process 12 in case the unlock phase command failed (e.g., when it is not received within a certain time period) (block 460), and further in response to failure to receive the unlock phase command, the CCP 20 can locally unlock the resource to which the original reservation command related and send the updated phase data to the BCP 30 (block 465).

According to examples of the presently disclosed subject matter, in case the unlock phase command is received at the CCP 20, for example from the originator interface 12, the CCP 20 can be configured to locally unlock the LU to which the phase command relates and send updated phase data (indicating that the LU is now unlocked) to the BCP 30 (block 470). According to examples of the presently disclosed subject matter, once the operations in block 470 are complete (e.g., a success notification is received from the BCP 30), the CCP 20 is adapted to send a success notification to the originator interface 12, in response to the unlock phase command (block 475). As mentioned above, the originator interface 12 can be responsive to the success indication associated with the unlock phase command for sending a success notification to the initiator of the reservation command.

As mentioned above, the BCP 30 can provide a backup for the CCP 20, and in case the CCP 20 fails, the BCP 30 can replace it as the central controlling process. The multiphase reservation synchronization process according to some examples of the presently disclosed subject matter can include provisions for enabling the BCP 30 to replace the CCP 20 in case the latter fails. An example of the manner by which the BCP 30 can be configured to operate in case the CCP 20 fails shall now be provided.

According to examples of the presently disclosed subject matter, in case the CCP 20 abnormally terminates, the BCP 30 can be configured to take over the role of the CCP 20 in the storage system 100. According to examples of the presently disclosed subject matter, the CCP 20 can be configured to implement measures for detecting a failure and in response to detecting a failure the CCP 20 can be configured to initiate a takeover process with the BCP 30. For example, the CCP 20 can be configured to detect internal anomalies, including for example failure to allocate internal threads or failure to allocate memory, and response to detecting an internal anomaly, the CCP 20 can be configured to terminate itself. The CCP 20 can be configured to instruct the BCP 30 to take over as the central controlling process, or the BCP 30 can be configured to detect that the CCP 20 terminated and initiate the takeover independently.

According to examples of the presently disclosed subject matter, the BCP 30 can also be configured to and responsible for detecting CCP 20 failures. For example, the BCP 30 (possibly in cooperation with other processes in the system 100) can periodically check whether the CCP 20 is alive and is functioning properly. In case it is determined that the CCP 20 is not functioning properly, the BCP can be configured to take over the role of the central controlling process.

According to examples of the presently disclosed subject matter, as part of taking over the role of the CCP 20, the BCP 30 can be configured to perform preliminary or preparatory operations. By way of example the preliminary or preparatory operations can include recreating the state of an in-progress reservation operation. For example, the BCP 30 can determine if its backup data includes lock phase data for which there is no record of a corresponding unlock phase data. It would be appreciated that in accordance with examples of the presently disclosed subject matter, the existence of lock phase backup data record without a corresponding unlock phase backup data record can indicate that the common resource to which the lock phase backup data relates was locked but the multiphase reservation synchronization protocol was terminated before completion and the common resource was not yet unlocked when the CCP 20 terminated. Further by way of example, the preliminary or preparatory operations can include requesting each one (or only some) of the interface processes 10 to resend any reservation phase command (lock phase command, execute phase command or unlock phase command) that was issued by the interface and for which no response was received from the CCP 20, or for which the CCP 20 did not respond with a success notification.

According to examples of the presently disclosed subject matter, after the BCP 30 takes over the role of the CCP 20, and is defined in the system 100 as the CCP 20, it is configured to initiate a new BCP 30 to replace the process that has now become the CCP 20, and instructs the new CCP 20 and BCP 30 to synchronize the phase data from the new CCP 20 to the new BCP 30.

There are now provided non-limiting examples of scenarios of CCP 20 failure at different stages of the multiphase reservation synchronization protocol. With respect to each CCP 20 failure scenario, there is provided a non-limiting example of the operation that can be implemented by the various components of the system 100, according to examples of the presently disclosed subject matter.

In a first example, the CCP 20 fails, following locally locking an LU (or any other common resource) on the CCP 20, but prior to backing up the lock phase data to the BCP 30. According to examples of the presently disclosed subject matter, when the BCP 30 is in the preliminary or preparatory stage before taking over as the new CCP 20 it is not aware of the lock phase data since it was not backed up to the BCP 30. According to examples of the presently disclosed subject matter, as part of the preliminary or preparatory stage the BCP 30 requests the interface process 12 which originated the lock phase command to provide it with any reservation phase command (lock phase command, execute phase command or unlock phase command) that was issued by the interface 12 and for which no response was received from the CCP 20, or for which the CCP 20 did not respond with a success notification. Since the CCP 20 is configured to issue a success notification for the lock phase command only after the BCP 30 reports that the phase data was successfully backed up on the BCP 30, and no such notification was issued under the circumstances described, the originator interface 12 did not receive a success notification from the CCP 20 for the lock phase command, and thus the originator interface 12 would resend the lock phase command to the new CCP 20 (the previous BCP 30), and the new CCP 20 will process the lock phase command according to the examples of the presently disclosed subject matter described above, for example with reference to FIGS. 2-4.

In a further example, the CCP 20 failed after successfully backing up the lock phase data on the BCP 30. In such a case, the new CCP may not have data regarding whether or not a success notification was sent (or has not yet been sent) to the originator interface 12. Therefore, according to examples of the presently disclosed subject matter, when the CCP 20 failed after successfully backing up the lock phase data on the BCP 30, as part of the preliminary or preparatory stage, the BCP 30 requests all interface processes to resend any pending commands. In case the originator interface 12 did not receive a success notification for the lock phase command, it will resend the lock phase command to the new CCP. Since the BCP 30 already had in backup the lock phase command and was able to recreate the local lock for the common resource referenced in the lock phase command from the originator interface 12 (in other words, the lock is already taken), the new CCP 20 can be configured to simply issue a success notification in connection with the lock phase command to the originator interface 12.

In yet a further example, the CCP 20 failed after reporting success in respect of the lock phase command and subsequently received the execute phase command, but before completing the execute phase command, i.e., before reporting success in response to the execute phase command. Since the originator interface 12 did not receive a success notification from the CCP 20 in response to the execute phase command, the originator interface 12 would resend the execute phase command to the new CCP 20 (the previous BCP 30), and the new CCP 20 will send a corresponding reservation command to each one of the other interfaces 14A-14N. It would be appreciated that the reservation commands are idempotent. From this point the process is implemented according to the examples of the presently disclosed subject matter described above.

In yet a further example, the CCP 20 failed after reporting success in response to the execute phase command but before syncing the unlock phase command phase data to the BCP 30. According to examples of the presently disclosed subject matter, when the BCP 30 is in the preliminary or preparatory stage before taking over as the new CCP 20 it is not aware of the unlock phase data since it was not backed up to the BCP 30. According to examples of the presently disclosed subject matter, as part of the preliminary or preparatory stage the BCP 30 requests the interface process 12 which originated the lock phase command to provide it with any reservation phase command that was issued by the interface 12 and for which no response was received from the CCP 20, or for which the CCP 20 did not respond with a success notification. Since the CCP 20 is configured to issue a success notification for the unlock phase command only after the BCP 30 reports that the phase data was successfully backed up on the BCP 30, and no such notification was issued under the circumstances described, the originator interface 12 did not receive a success notification from the CCP 20 for the unlock phase command, and thus the originator interface 12 would resend the unlock phase command to the new CCP 20 (the previous BCP 30), and the new CCP 20 will process the unlock phase command according to the examples of the presently disclosed subject matter described above, for example with reference to FIGS. 2-4.

In still a further example, the CCP 20 failed after successfully backing up the unlock phase data on the BCP 30. In such a case, the new CCP may not have data regarding whether or not a success notification was sent (or has not yet been sent) to the originator interface 12. Therefore, according to examples of the presently disclosed subject matter, when the CCP 20 failed after successfully backing up the unlock phase data on the BCP 30, as part of the preliminary or preparatory stage, the BCP 30 requests all interface processes to resend any pending commands. In case the originator interface 12 did not receive a success notification for the unlock phase command it will resend the lock phase command to the new CCP. Since the BCP 30 already had in backup the unlock phase and was able to locally unlock the common resource referenced in the unlock phase command from the originator interface 12, the new CCP 20 can be configured to simply issue a success notification in connection with the unlock phase command to the originator interface 12.

In the examples of the presently disclosed subject matter described above, the serialization of the multiphase reservation synchronization protocol phase commands (lock phase command, execute phase command, and unlock phase command) is controlled and managed by the originator interface, and the CCP manages the execute phase across the system's other interface processes. It would be appreciated that in further examples of the presently disclosed subject matter, the CCP can be configured to control the serialization of the multiphase reservation synchronization protocol phase commands as well as the execute phase across the system's other interface processes. Accordingly, in some examples of the presently disclosed subject matter, upon receiving a reservation command from an external initiator (e.g., a persistent reservation from a SCSI host), the interface process of the storage system which receives the reservation command from the initiator can be configured to forward the reservation command to the controlling process and the controlling process can be configured to carry out the multiphase reservation synchronization protocol.

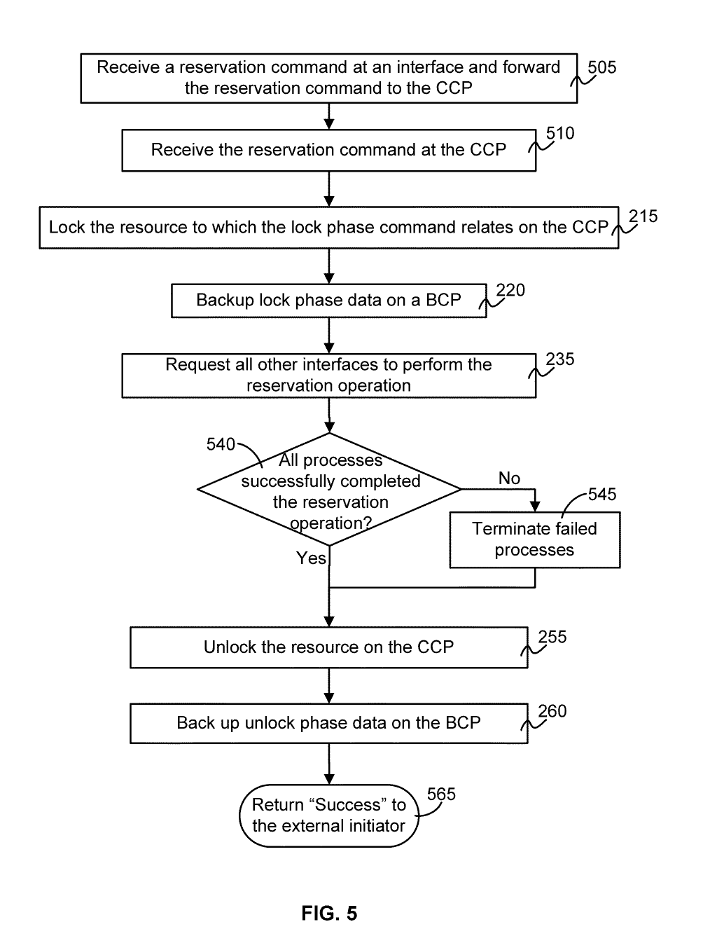

FIG. 5 is a flowchart illustration of one possible implementation of the multiphase reservation synchronization protocol according to examples of the presently disclosed subject matter. In FIG. 5 and in accordance with examples of the presently disclosed subject matter, the CCP 20 can be configured to control the serialization of the multiphase reservation synchronization protocol phase commands. At block 505 a reservation command from an external initiator is received by an interface of the storage system 100, and the interface forwards the reservation command to the CCP 20. According to examples of the presently disclosed subject matter, in the configuration where the CCP 20 is responsible for controlling the serialization of the multiphase reservation synchronization protocol phase commands, the interface which receives the reservation command from the initiator can act simply as an entry point to the storage system (with the necessary interfacing functions/services), and it does not have any special role or function in the implementation of the multiphase reservation synchronization protocol.

At block 510 the reservation command is received at the CCP 20. Upon receiving the reservation command, the CCP can be configured to initiate the multiphase reservation synchronization process in respect of the reservation command. The CCP 20 locally locks the resource to which the reservation command relates (block 215), and backs up the lock phase data on the BCP 30 (block 220).

After receiving a success notification from the BCP 30, indicating that the lock phase data was successfully backed up on the BCP 30, the CCP 20 is configured to proceed to the execute phase. At block 235 the CCP 20 is configured to request each one of the multiple interface 10 to locally lock the resource to which the reservation command relates. According to examples of the presently disclosed subject matter, in this configuration of the CCP 20, in the execute phase, the CCP 20 is configured to send the reservation command to interface through which the reservation command from the initiator was received in the system, as well as to each one of the other interfaces. This is because the receiving interface did not yet locally lock the resource to which the reservation command relates, and will do so when requested by the CCP 20 in the execute phase.

The CCP 20 is configured to wait for success notification from the interfaces (block 540). The CCP 20 can be configured to terminate any interface from which a success notification was not received at the CCP 20 (e.g., within a certain timeout period) (block 545).

According to examples of the presently disclosed subject matter, following receipt of the success notifications from the interfaces, and, if necessary, termination of the failed interfaces, the CCP 20 can be configured to proceed to the unlock phase. According to examples of the presently disclosed subject matter, in the unlock phase, the CCP is configured to locally unlock the resource to which the reservation command relates (block 255), and further as part of the unlock phase, the CCP is configured to backup the unlock phase data on the BCP 30 (block 260).

According to examples of the presently disclosed subject matter, upon receiving a success notification form the BCP 30 indicating that the unlock phase data was successfully backed up on the BCP 30, the CCP 20 is configured to issue a success notification that is to be communicated to the initiator (block 565), possibly through one of the interfaces.

Having described various features and implementations of the multiphase reservation synchronization protocol according to examples of the presently disclosed subject matter, there are provided examples of possible implementations of the CCP, BCP and interfaces. Before discussing the details of such examples, it should be appreciated that the implementations are provided herein by way of non-limiting example only, and that various other configurations can be devised for implementing the proposed multiphase reservation synchronization protocol.

According to examples of the presently disclosed subject matter, the CCP 20 can maintain and manage a list of all active interfaces 10. When an execute phase command is received, the CCP 20 can look up the interfaces other than the originator interface and can issue a reservation command to the interfaces other than the originator interface.

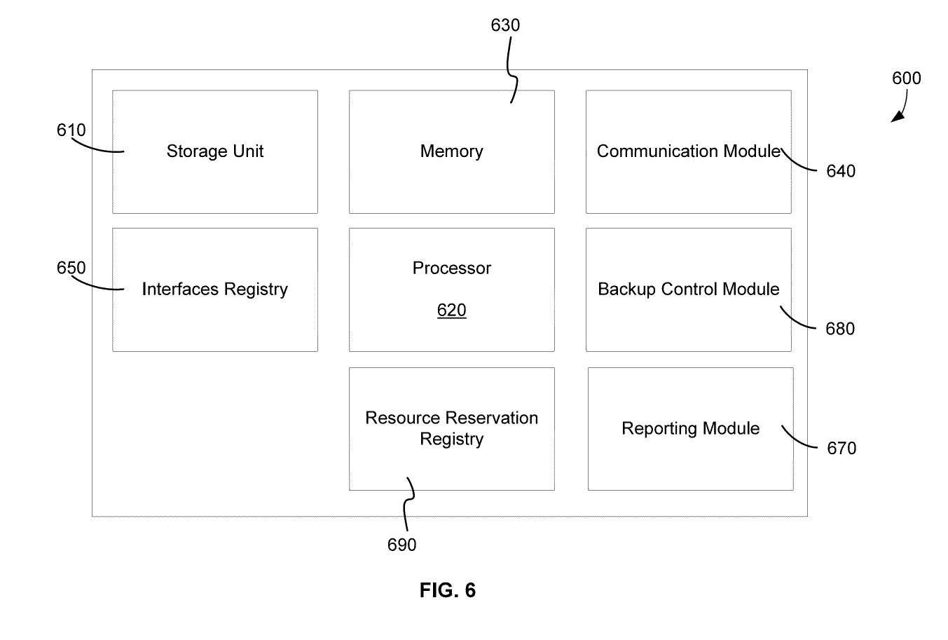

Reference is now made to FIG. 6, which is a block diagram illustration of a CCP according to examples of the presently disclosed subject matter. According to examples of the presently disclosed subject matter the CCP 600 can include a storage unit 610 in which a set of computer readable instructions can be stored, including instructions for carrying out the process blocks involving the CCP at least in FIGS. 4 and/or 5 or described above, including with reference to FIGS. 4 and/or 5. The CCP 600 can also include a processor 620 and a memory 630. The memory 630 and processor 620 can operate cooperatively to process data from the storage unit 610 or from external sources, and to provide any output of the CCP 600, according to any processing or output operation of the CCP shown at least in FIGS. 4 and/or 5, or described above, including with reference to FIGS. 4 and/or 5.

According to examples of the presently disclosed subject matter, the CCP 600 can include a communication module 640. The communication module 640 can be configured to enable to CCP 600 to communicate with any or with each of the interfaces 10, the BCP 30 and/or the common storage resource 40. According to examples of the presently disclosed subject matter, the communication module 640 can also enable the CCP 600 to communication directly with the hosts 50 (or with any other external entity).

Still further by way of example, the CCP 600 can include an interfaces registry 650 where the active or valid interfaces 10 of the storage system 100 are registered. According to examples of the presently disclosed subject matter, the CCP 600, for example, by instructions from the processor 620, can add and remove interfaces from the registry, for example, when a new interface is detected (or registers with the CCP 600), or when an interface is terminated.

According to examples of the presently disclosed subject matter, the CCP 600 can further include a resource reservation registry 690, where indications with respect to locked resources are stored. The resource reservation registry 690 can be updated, e.g., according to instructions by the processer 620, when the reservation phase of a given resource as implemented by the CCP 600 changes from unlocked to locked (a record for the now locked resource is added to the registry) and when the reservation phase changes from locked to unlock (the record for the resource is removed from the registry).

According to examples of the presently disclosed subject matter, the CCP 600 can include a reporting module 670. In some examples of the presently disclosed subject matter, the reporting module 670, e.g., according to instructions from the processor 620, can be configured to provide a success indication upon completion of the operations related to each one of the lock phase, execute phase and unlock phase. In some examples of the presently disclosed subject matter, the success notification can be communicated by the CCP 600 in response to the reporting module 670 indicating that the operations related to a certain phase completed successfully. In other examples of the presently disclosed subject matter, the success indications from reporting module 670 are addressed internally, within the CCP 600, and only the success indication following the completion of the operations related to the unlock phase is communicated to the external initiator to indicate that the reservation command was serviced successfully.

Still further according to examples of the presently disclosed subject matter, the CCP 600 can include a backup control module 680 that is adapted to control the interaction of the CCP 600 with a BCP for backing up the lock phase and unlock phase data on the BCP. The backup control module 680 can be configured to generate and transmit the backup messages following an update of the reservation phase (a lock phase or an unlock phase) of a given resource. The backup control module 680 can also be adapted to wait for a success notification from the BCP indicating that backup data that was sent to the BCP for backup was successfully stored on the BCP. The backup control module 680, possibly in cooperation with the processor 620, can indicate to the reporting module 670 when certain backup data related to a certain reservation phase (a lock phase or an unlock phase) was successfully backed up on the BCP.

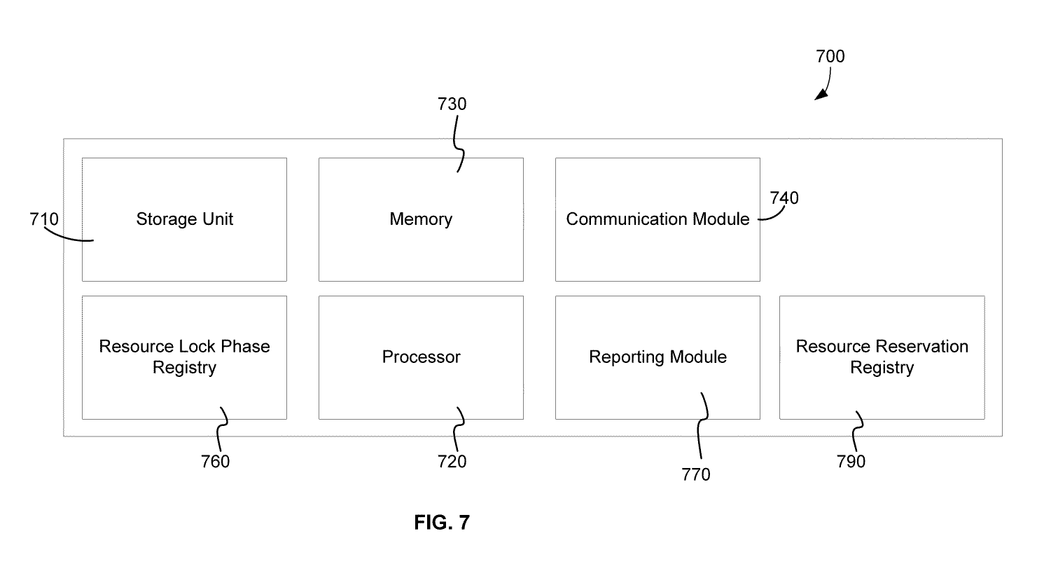

Turning now to FIG. 7, there is shown a block diagram illustration of one of the multiple interfaces of the storage system, according to examples of the presently disclosed subject matter. For illustration purposes, the interface 700 shown in FIG. 7 is described with the functionality of an originator interface supporting at least the process in FIGS. 4 and/or 5 or described above, including with reference to FIGS. 4 and/or 5. It would be appreciated that when the interface is one of the plurality of other interfaces which are involved only in the execute phase, only part of the functionality of the originator interface is necessary, albeit the capabilities and the structure of each of the interfaces can support such additional functionality in case it is required to operate as an originator interface in subsequent multi-phase reservation synchronization processes.

According to examples of the presently disclosed subject matter the originator interface 70 can include a storage unit 710 in which a set of computer readable instructions can be stored, including instructions for carrying out the process blocks involving the originator interface at least as shown in FIG. 3 and described with reference thereto above. The Storage unit 710 can also include instructions for carrying out the process blocks involving the interfaces other than the originator interface (particularly in the execute phase) at least as shown in FIGS. 3-5 and described above.

The originator interface 700 can also include a processor 720 and a memory 730. The memory 730 and processor 720 can operate cooperatively to process data from the storage unit 710 or from external sources, and to provide any output of the originator interface 700 shown at least in FIG. 3 or described above, including with reference to FIG. 3. The memory 730 and processor 720 can operate cooperatively to process data from the storage unit 710 or from external sources, and to provide any output of the originator interface 700, according to any processing or output operation shown at least in FIG. 3 or described above, including with reference to FIG. 3. The memory 730 and processor 720 can operate cooperatively to process data from the storage unit 710 or from external sources, to also to perform any operation or to provide any output of the interface when acting, as on the multiple other interfaces (not the originator interface), according to any processing or output operation shown at least in FIGS. 3-5 or described above, including with reference to FIGS. 3-5.

According to examples of the presently disclosed subject matter, the originator interface 700 can include a communication module 740. The communication module 740 can be configured to enable to originator interface 700 to communicate at least with external hosts and with the CCP.

According to examples of the presently disclosed subject matter, the originator interface 700 can further include a lock phase registry 760, where the originator interface 700, e.g., by instructions from the processor 720, is configured to update and store the lock phase of a given resource in the storage system. According to examples of the presently disclosed subject matter, the originator interface 700 can record in the lock phase registry 760 a lock phase of a given storage resource, indicating the resource is currently locked and an unlock phase indicating that the resource is currently unlocked. According to examples of the presently disclosed subject matter, the originator interface 700 can record in the lock phase registry 760 an execute phase, when the originator 700 is in the execute phase.

According to examples of the presently disclosed subject matter, the originator interface 700 can include a separate resource reservation registry 790, where indications with respect to locked resources are stored. The resource reservation registry 790 can be updated, e.g., according to instructions by the processor 720, when the reservation phase of a given resource as implemented by the originator interface 700 changes from unlocked to locked (a record for the now locked resource is added to the registry) and when the reservation phase changes from locked to unlock (the record for the resource is removed from the registry). It would be appreciated that having a separate data structure, where locked resources are registered, can promote performance of the system under certain conditions.

It would be appreciated that according to examples of the presently disclosed subject matter, the separate resource reservation registry 790 can be used by the interface when acting as one of the other interfaces (another one of the interfaces is an originator interface) for locally locking a given resource.

According to examples of the presently disclosed subject matter, the originator interface 700 can include a reporting module 770. In some examples of the presently disclosed subject matter, the reporting module 770 can be configured to provide a success indication following the completion of the operations related to the unlock phase to the external initiator to indicate that the reservation command was serviced successfully.

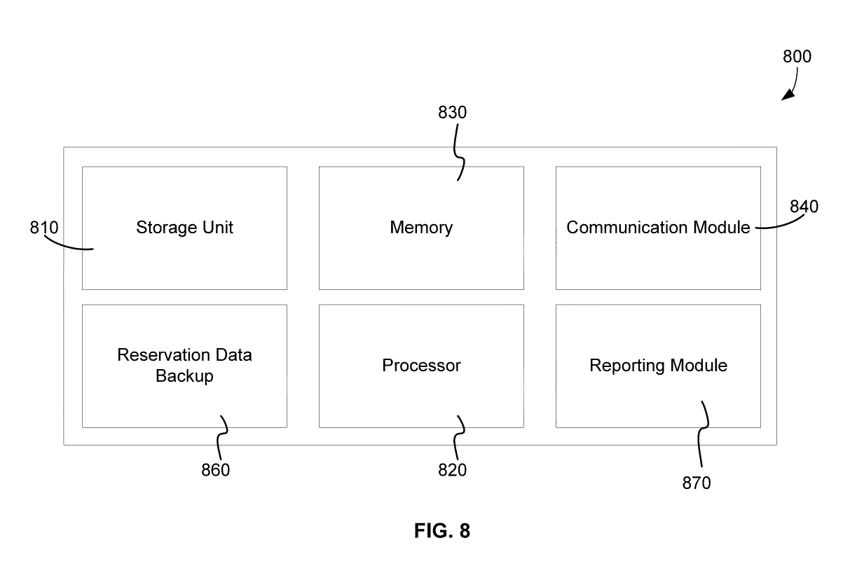

Reference is now made to FIG. 8, showing a block diagram illustration of a BCP according to examples of the presently disclosed subject matter. According to examples of the presently disclosed subject matter the BCP 800 can include a storage unit 810 in which a set of computer readable instructions can be stored, including instructions for carrying out the process blocks involving the BCP at least in FIGS. 2-5 or described above, including with reference to FIGS. 2-5. The BCP 800 can also include a processor 820 and a memory 830. The memory 830 and processor 820 can operate cooperatively to process data from the storage unit 810, and to provide any output of the BCP 800, according to any processing or output operation of the BCP shown at least in FIGS. 2-5, or described above, including with reference to FIGS. 2-5.

It would be appreciated, that the BCP 800 can include further components, for example, all of the components of the CCP, including for example at least the component of the CCP 600 shown in FIG. 6 or described above with reference to FIG. 6. Further by way of example, it would be appreciated that the storage unit 810 can include instructions and configurations which can be used, for example in cooperation with the memory 830 and the processing unit 820 to reconfigure the BCP 800 so that it becomes and operates as a CCP. The transition from a BCP to a CCP can involve, inter-alia, processing of reservation phase backup data to recreate an exact or an approximate image of the status of the various reservation phases that were implemented by the CCP at the time of its failure. As mentioned above, according to examples of the presently disclosed subject matter, under certain circumstances the multiphase reservation synchronization protocol can allow a certain gap between the actual implementation phase of the multiphase reservation synchronization protocol and the backup data, but there are provisions for closing any such gap if and when the CCP fails and the BCP takes over the role of the CCP.

It would be further appreciated that the configurations necessary for carrying out the backup operations described above, and for reconfiguring the BCP to act and operate as a CCP can be stored in the storage unit 810, and can be invoked when a failure of the CCP is detected.

According to examples of the presently disclosed subject matter, the BCP 800 can include a communication module 840. The communication module 840 can be configured to enable to BCP 800 to communicate with the CCP. According to examples of the presently disclosed subject matter, the communication module 840 can also enable the BCP 800 to communicate with any one of: the interface, the storage resources, the hosts 50 (or with any other external entity), when the CCP fails and the BCP 800 is taking over as CCP.

Still further by way of example, the BCP 860 can include a backup interfaces registry (not shown) where the active or valid interfaces 10 of the storage system 100 can be registered, for example, based on updates from the CCP. In further examples of the presently disclosed subject matter, the interfaces registry in the BCP is not used while the BCP is operating as a backup unit and is only updated when the CCP fails. As mentioned above, when the CCP fails, the BCP can be configured to communicate with the active interfaces, and can populate the interface registry based on such communications.

According to examples of the presently disclosed subject matter, the BCP 800 can further include a reservation data backup 860, where the BCP 800, e.g., by instructions from the processor 820, can be configured to update and store the backup data that is received from the CCP. According to examples of the presently disclosed subject matter, the backup data received from the CCP relates to a lock phase or to an unlock phase of a certain resource, and likewise, the reservation data backup 860 can store backup data that is related to a lock phase or to an unlock phase of a certain resource. As mentioned above, the backup data in the reservation data backup 860 can be processed and used to reconstruct an exact or approximate image of the status of the various reservation phases that were implemented by the CCP at the time of its failure. As mentioned above, according to examples of the presently disclosed subject matter, under certain circumstances the multiphase reservation synchronization protocol can allow a certain gap between the actual implementation phase of the multiphase reservation synchronization protocol and the backup data, but there are provisions for closing any such gap if and when the CCP fails and the BCP takes over the role of the CCP. For example, in case the CCP failed during implementation of an execute phase, the BCP is not updated with the implementation of this phase and possibly is not even aware (from the backup data that the BCP has) that the CCP was in the execution phase. However, as mentioned above, when the BCP becomes the new CCP, the multiphase reservation synchronization protocol can include provisions for identifying such gaps (as well as other gaps) and also includes provisions for completing the multiphase reservation synchronization protocol, even if such gaps exist.

According to examples of the presently disclosed subject matter, the BCP 800 can include a reporting module 870. In some examples of the presently disclosed subject matter, the reporting module 870, e.g., according to instructions from the processor 820, can be configured to provide a success indication upon completion of the backup operations related to each one of the lock phase and the unlock phase.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

1. A method of managing reservation-control in a storage system that consists of a plurality of interfaces and a common storage resource, the method comprising:
responsive to receiving at an originator interface a reservation command related to the common storage resource, implementing a multi-phase reservation synchronization protocol including:
a lock phase consisting of:
locking the resource on a central controlling process,
backing up respective lock phase data on a backup control process, and
issuing a lock phase completion indication;
an execution phase consisting of:
executing locally on each one of the plurality of interfaces a reservation operation, and
issuing an execute phase completion indication; and
an unlock phase consisting of:
unlocking the resource on the central controlling process;
backing up respective unlock phase data on a backup control process, and
issuing an unlock phase completion indication.

2. The method according to claim 1, wherein said lock phase is initiated by the originator interface in response to receiving the reservation command, and said execution and unlock phases are initiated by the originator in response to receiving the lock phase completion and the execute phase completion indications, respectively.

3. The method according to claim 1, further comprising:
receiving at the originator interface the reservation command;
forwarding the reservation command to the central controlling process,
and wherein said multi-phase reservation synchronization protocol is initiated for the reservation command by the central controlling process, including initiating said lock phase, said execution phase and said unlock phase.

4. The method according to claim 1, wherein the execution phase includes receiving at the central controlling process an acknowledgment of the execution of the reservation operation on each one of the plurality of interfaces, and wherein said issuing an execute phase completion indication is responsive to said receiving at the central controlling process an acknowledgment of the execution of the reservation operation on each one of the plurality of interfaces.

5. The method according to claim 3, further comprising in case the central controlling process failed:
configuring the backup control process as a replacement controlling process;
implementing a takeover process including requesting each one of the plurality of interfaces to provide the replacement controlling process with any reservation phase command that was issued by the interface and for which no response was received from the central controlling process; and
processing responses from the plurality of interfaces using the back up phase data to determine a current phase of a reservation command.

6. A storage system, comprising:
a plurality of interfaces;
a common storage resource;
a central controlling process; and
a backup controlling process,
wherein in response to receiving at an originator interface a reservation command related to the common storage resource, implementing a multi-phase reservation synchronization protocol including:
a lock phase consisting of:
locking the common storage resource on the central controlling process,
backing up lock phase data related to the lock on a backup control process, and
issuing a lock phase completion indication to the originator interface;
an execution phase consisting of:
executing locally on each one of the plurality of interfaces a reservation operation, and
issuing an execute phase completion indication to the originator interface; and
an unlock phase consisting of:
unlocking the resource on the central controlling process;
backing up respective unlock phase data on a backup control process, and
issuing an unlock phase completion indication to the originator.

7. A program storage device readable by machine, tangibly embodying a program of instructions executable by the machine to perform a method of managing reservation-control in a storage system that consists of a plurality of interfaces and a common storage resource, the method comprising:
responsive to receiving at an originator interface a reservation command related to the common storage resource implementing a multi-phase reservation synchronization protocol including:
a lock phase consisting of:
locking the resource on a central controlling process,
backing up respective lock phase data on a backup control process, and
issuing a lock phase completion indication;
an execution phase consisting of:
executing locally on each one of the plurality of interfaces a reservation operation, and
issuing an execute phase completion indication; and
an unlock phase consisting of:
unlocking the resource on the central controlling process;
backing up respective unlock phase data on a backup control process, and
issuing an unlock phase completion indication.
